(19) United States
(12) Patent Application Publication
(10) Pub. No.: US 2012/0184205 A1
(43) Pub. Date: Jul. 19, 2012

(54) STATEFUL PAGING GUARD DEVICES AND METHODS FOR CONTROLLING A STATEFUL PAGING GUARD DEVICE

(75) Inventors: Achim Luft, Braunschweig (DE); Andreas Schmidt, Braunschweig (DE)

(73) Assignee: INFINEON TECHNOLOGIES AG, Neubiberg (DE)

(21) Appl. No.: 13/006,552

(22) Filed: Jan. 14, 2011

(51) Int. Cl. H04B 17/02

(52) U.S. Cl. 455/9

(57) ABSTRACT

In an embodiment, a stateful paging guard device is provided. The stateful paging guard device may include: a state determiner configured to determine state information indicating whether a terminal device is in an operation state of reduced energy consumption; a receiver configured to receive data directed to the terminal device; and a relay determiner configured to determine whether the data is to be relayed to the terminal device based on the state information.

### TECHNICAL FIELD

Embodiments relate generally to stateful paging guard devices and methods for controlling a stateful paging guard device.

### BACKGROUND

Mobile radio communication devices may enter a mode of reduced energy consumption in case no user data is to be transmitted from or to the mobile radio communication device. In the mode of reduced energy consumption, the mobile radio communication device may receive and evaluate paging data, and may enter a mode of full operability in case the received paging data indicates that user data directed to the mobile radio communication device is available.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows a communication system according to an embodiment;

FIG. 2 shows a state diagram according to an embodiment;

FIG. 3 shows a stateful paging guard device according to an embodiment;

FIG. 4 shows a stateful paging guard device according to an embodiment;

FIG. 5 shows a flow diagram illustrating a method for controlling a stateful paging guard device according to an embodiment;

FIG. 6 shows a stateful paging guard device according to an embodiment;

FIG. 7 shows a flow diagram illustrating a method for controlling a stateful paging guard device according to an embodiment;

FIG. 8 shows a diagram illustrating machine to machine market segments according to an embodiment;

FIG. 9 shows a network architecture in accordance with an embodiment;

FIG. 10 shows a flow diagram illustrating a paging procedure in accordance with an embodiment; and

FIG. 11 shows a packet header in accordance with an embodiment.

### DESCRIPTION

Terminal devices, for example mobile radio communication devices may enter a mode of reduced energy consumption in case no user data is to be transmitted from or to the mobile radio communication device. In the mode of reduced energy consumption, the mobile radio communication device may receive and evaluate paging data, and may enter a mode of full operability in case the received paging data indicates that user data directed to the mobile radio communication device is available. For example, a terminal device, for example a user equipment (UE), may be paged and may transit from RRC_idle state to RRC_connect state, like will be described in more detail below, if data arrive from the Internet for the UE. According to various embodiments, devices and methods are provided to prevent a terminal device from being paged or triggered by someone not authorized to do so, for example someone else than the owner of that device, so that the terminal device stays in an operation state of reduced energy consumption unless the authorized person, for example the owner of that terminal device, whishes that the terminal device is in another operation state.

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any embodiment or design described herein as “exemplary” is not necessarily to be construed as preferred or advantageous over other embodiments or designs.

A terminal device according to various embodiments may be any device or radio device that may use radio to transmit and/or receive information. According to various embodiments, a radio device may be a wireless device. According to various embodiments, a radio device may be a mobile device. For example, a radio device may be a device configured for wireless communication. In various embodiments, a radio device may be a mobile radio communication device, and a mobile radio communication device may be an end-user mobile device (MD). In various embodiments, a mobile radio communication device may be any kind of mobile telephone, personal digital assistant, mobile computer, or any other mobile device configured for communication with a mobile communication base station (in other words: with a base station (BS)) or an access point (AP) and may be also referred to as a User Equipment (UE), a mobile station (MS) or an advanced mobile station (advanced MS, AMS), for example in accordance with IEEE 802.16m.

According to various embodiments, a stateful paging guard device and/or a terminal device may be configured according to at least one of the following radio access technologies: a Global System for Mobile Communications (GSM) radio access technology, a General Packet Radio Service (GPRS) radio access technology, an Enhanced Data Rates for GSM Evolution (EDGE) radio access technology, and/or a Third Generation Partnership Project (3GPP) radio access technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), PHS (Personal Handy-phone System), WiDEN (Wideband Integrated Digital Enhanced Network), iBurst, and Unlicensed Mobile Access (UMA, also referred to as 3GPP Generic Access Network, or GAN standard)).

A stateful paging guard device may include a memory which may for example be used in the processing carried out by the stateful paging guard device. A terminal device may include a memory which may for example be used in the processing carried out by the terminal device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific stateful paging guard device may also hold for any other stateful paging guard device described herein. It will be understood that a stateful paging guard device is called stateful, because it may refer to a state (for example an operation state of a terminal device), and that a stateful paging guard device is called paging guard device because it may guard (or protect or shelter) in paging related embodiments.

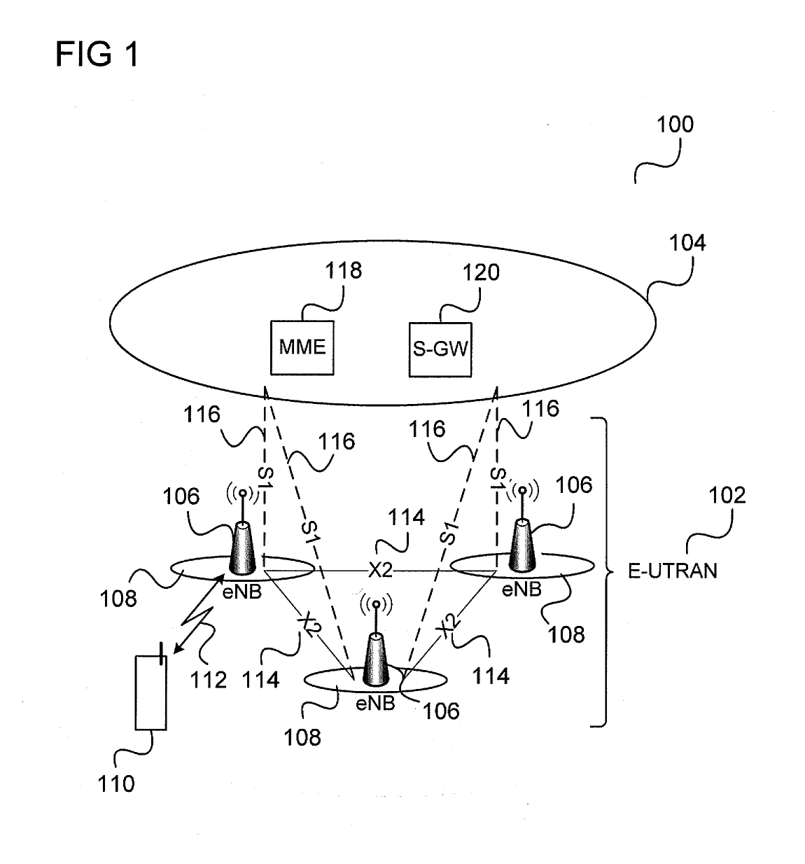

FIG. 1 shows a communication system 100 according to an embodiment.

The communication system 100 may be a cellular mobile communication system including a radio access network (e.g. an E-UTRAN, Evolved UMTS (Universal Mobile Communications System) Terrestrial Radio Access Network according to LTE (Long Term Evolution)) 102 and a core network (e.g. an EPC, Evolved Packet Core, according LTE) 104. The radio access network 102 may include base (transceiver) stations (e.g. eNodeBs, eNBs, according to LTE) 106. Each base station 106 may provide radio coverage for one or more mobile radio cells 108 of the radio access network 102.

A mobile terminal (also referred to as terminal device or as UE, user equipment) 110 located in a mobile radio cell 108 may communicate with the core network 104 and with other mobile terminals 110 via the base station providing coverage in (in other words operating) the mobile radio cell.

Control and user data may be transmitted between a base station 106 and a mobile terminal 110 located in the mobile radio cell 108 operated by the base station 106 over the air interface 112 on the basis of a multiple access method.

The base stations 106 may be interconnected with each other by a first interface 114, e.g. an X2 interface. The base stations 106 may also be connected by a second interface 116, e.g. an S1 interface, to the core network, e.g. to an MME (Mobility Management Entity) 118 and/or a Serving Gateway (S-GW) 120. For example, the MME 118 may be responsible for controlling the mobility of mobile terminals located in the coverage area of E-UTRAN, while the S-GW 120 may be responsible for handling the transmission of user data between mobile terminals 110 and core network 104.

In the following, it may be assumed that the base stations 106 may support various radio access technologies. For example, a base station 106 may provide a radio communication connection via the air interface between itself and the mobile terminal 110 according to LTE, UMTS, GSM (Global System for Mobile Communications), and EDGE (Enhanced Data Rates for GSM Evolution) radio access. Accordingly, the radio access network may operate as an E-UTRAN, a UTRAN, or a GERAN (GSM EDGE Radio Access Network). Analogously, the core network 104 may include the functionality of an EPC, a UMTS core network or a GSM core network. Two base stations 106 that support communication according to different radio access technologies may accordingly be coupled with different core networks 104 and belong to different radio access networks 102. Further, the second interface 116 may for example not be present between two base stations 106 that support different radio access technologies.

The mobile terminal 110 may communicate with the radio access network 102 through the air interface (also referred to as radio interface) 112 via the base stations 106 while moving around. The radio interface 112 between the mobile terminal 110 and the radio access network 102 may thus be implemented by providing the base stations 106 dispersed throughout the coverage area of the communication system 100 (e.g. a PLMN, public land mobile network).

Each base station of the communication system 100 may control communications within its geographic coverage area, namely its mobile radio cell 108. When the mobile terminal 110 is located within a mobile radio cell 108 and is camped on the mobile radio cell 108 (in other words is registered with the mobile radio cell 108) it may communicate with the base station 106 controlling that mobile radio cell 108. When a call is initiated by the user of the mobile terminal 110 or a call is addressed to the mobile terminal 110, radio channels may be set up between the mobile terminal 110 and the base station 106 controlling the mobile radio cell 108 in which the mobile station is located (and on which it is camped). If the mobile terminal 110 moves away from the original mobile radio cell 108 in which a call was set up and the signal strength on the radio channels established in the original mobile radio cell 108 weakens, the communication system may initiate a transfer of the call to radio channels of another mobile radio cell 108 into which the mobile terminal 110 moves.

As the mobile terminal 110 continues to move throughout the coverage area of the communication system 100, control of the call may be transferred between neighboring mobile radio cells 108. The transfer of calls from mobile radio cell 108 to mobile radio cell 108 may be termed handover (or handoff).

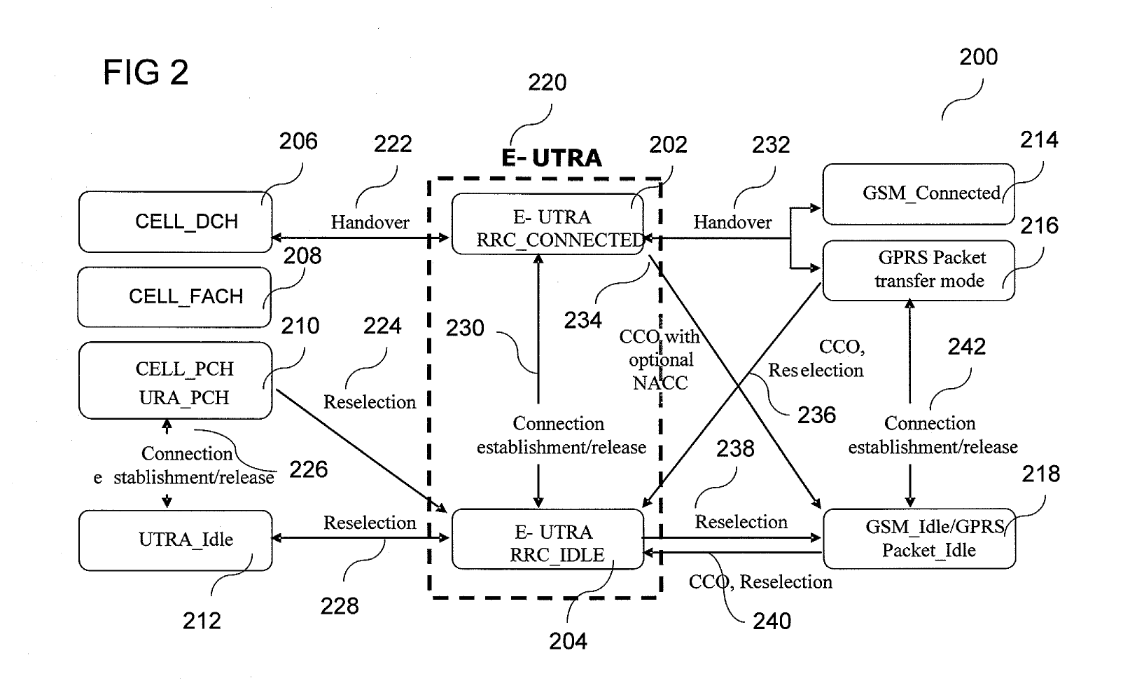

FIG. 2 shows a state diagram 200 according to an embodiment showing an overview 200 of the two E-UTRA RRC states E-UTRA RRC CONNECTED 202 and E-UTRA RRC IDLE 204, and also illustrates the inter-RAT mobility support between E-UTRA 200 (3.9G LTE, the two states depicted in the centre of FIG. 2), UTRA (3G UMTS, left part of the FIG. 2) and GERAN (2G and 2.5G, right part of FIG. 2).

As shown in FIG. 2, it may be switched between the state of E_UTRA RRC CONNECTED 202 and the state of E_UTRA RRC IDLE 204 by connection establishment/release as indicated by arrow 230. A switch between CELL_DCH state 206 and E-UTRA RRC CONNECTED state 202 may be performed by a handover, as indicated by arrow 222. In UMTS, a CELL_FACH state 208 may be provided. Furthermore, a switch between a CELL_PCH resp. URA_PCH state 210 and an UTRA_Idle state 212 may be performed by connection establishment/release as indicated by arrow 226. A switch from a CELL_PCH resp. URA_PCH state 210 to an E-UTRA RRC IDLE state 204 may be performed by reselection, as indicated by arrow 224. A switch between UTRA_Idle state 212 and an E-UTRA RRC IDLE state 204 may be performed by reselection, as indicated by arrow 228. A switch between an E-UTRA RRC CONNECTED state 202 and a GSM_Connected state 214 resp. GPRS Packet transfer mode 216 may be performed by handover, as indicated by arrow 232. A switch from an E-UTRA RRC_CONNECTED state 202 to a GSM_Idle/GPRS Packet_Idle state 218 may be performed by CCO (Cell Change Order) with optional NACC (Network Assisted Cell Change), as indicated by arrow 234. A switch from a GPRS Packet transfer mode 216 to an E-UTRA RRC IDLE state 204 may be performed by CCO resp. reselection, as indicated by arrow 236. A switch between a GPRS packet transfer mode 216 and a GSM_Idle/GPRS Packet_Idle state 218 may be performed by connection establishment/release, as indicated by arrow 242. A switch from an E-UTRA RRC IDLE mode 204 to a GSM_Idle/GPRS Packet_Idle state 218 may be performed by reselection, as indicated by arrow 238. A switch from a GSM_Idle/GPRS Packet_Idle state 218 to an E-UTRA RRC IDLE mode 204 may be performed by CCO resp. reselection, as indicated by arrow 240.

In various embodiments, the two distinct UE states in LTE (E-UTRA) may be RRC IDLE and RRC CONNECTED.

In various embodiments, in RRC IDLE, mobility may be UE controlled.

In various embodiments, in RRC IDLE, a UE specific discontinuous reception (DRX) may be configured by upper layers.

In various embodiments, in RRC IDLE, the UE may acquire system information (SI).

In various embodiments, in RRC IDLE, the UE may monitor a paging channel to detect incoming calls, system information change, and for ETWS (Earthquake and Tsunami Warning System) capable UEs, ETWS notifications.

In various embodiments, in RRC IDLE, the UE may perform neighboring cell measurements for the cell (re-)selection process.

In various embodiments, a UE may be in RRC_CONNECTED, when an RRC connection has been established.

In various embodiments, in RRC_CONNECTED, mobility may be controlled by the network (handover and cell change order).

In various embodiments, in RRC_CONNECTED, data may be transferred to/from UE.

In various embodiments, in RRC_CONNECTED, at lower layers, the UE may be configured with a UE specific discontinuous reception (DRX).

In various embodiments, in RRC_CONNECTED, the UE may acquire system information (SI).

In various embodiments, in RRC_CONNECTED, the UE may monitor a paging channel and/or SIB Type 1 content to detect SI change, and for ETWS capable UEs, ETWS notifications.

In various embodiments, in RRC_CONNECTED, the UE may monitor the control channels associated with the shared data channel to determine if data is scheduled for it.

In various embodiments, in RRC_CONNECTED, the UE may provide channel quality and feedback information.

In various embodiments, in RRC_CONNECTED, the UE may perform neighboring cell measurements and reporting to assist the network in making handover decisions.

According to various embodiments, the two RRC (Radio Resource Control) states RRC Idle (which may be an example for an operation state of reduced energy consumption) and RRC Connected in E-UTRA may be as follows:

### RRC IDLE

Mobility may be controlled by the mobile terminal 110 (for example a M2M (machine-to-machine) device 110).
The mobile terminal 110
   may acquire system information (SI);
   may monitor a paging channel to detect incoming calls and SI change notifications; and
   may perform neighboring cell measurements for the cell (re-)selection process.

### RRC CONNECTED

A mobile terminal 110 (for example an M2M device 110) may be in RRC_CONNECTED when an RRC connection has been established.
Mobility may be controlled by the radio access network 102 (handover and cell change order).
The mobile terminal 110
   may acquire system information (SI);
   may monitor a paging channel and/or SIB (system information block) Type 1 content to detect SI change; and
   may perform neighboring cell measurements and measurement reporting to assist the network in making handover decisions.

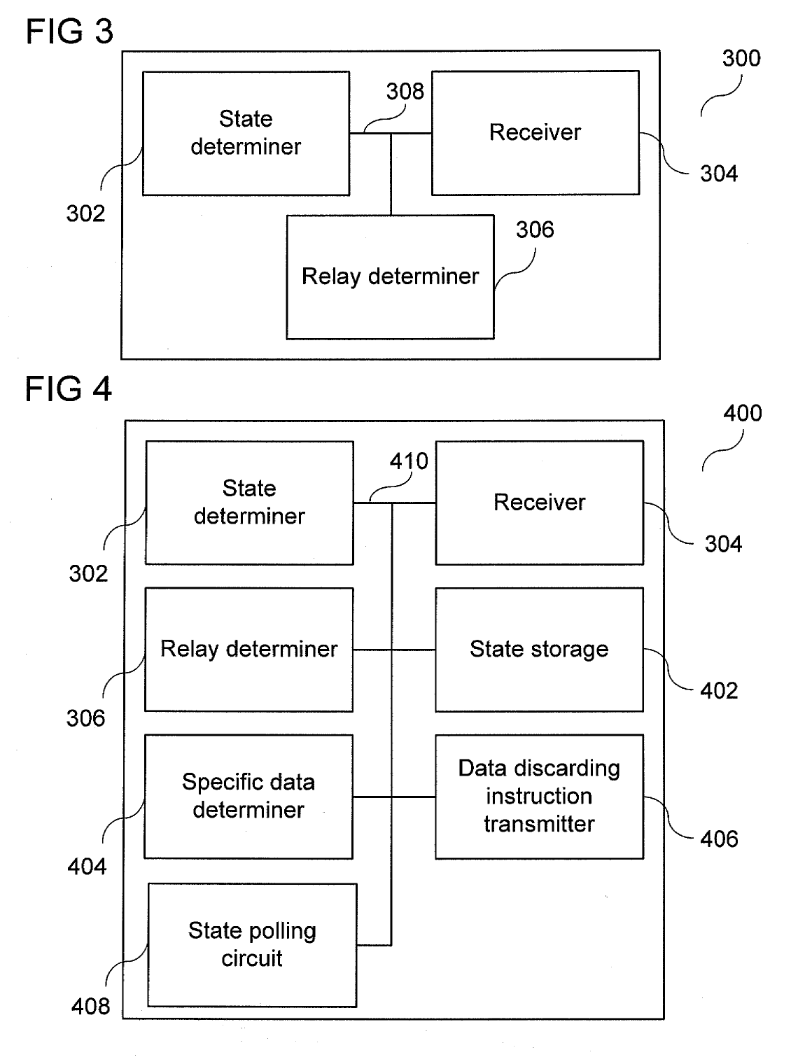

FIG. 3 shows a stateful paging guard device 300 according to an embodiment. The stateful paging guard device 300 may include a state determiner 302 (in other words a state determining circuit) configured to determine state information indicating whether a terminal device (not shown in FIG. 3) is in an operation state of reduced energy consumption; a receiver 306 configured to receive data directed to the terminal device; and a relay determiner 306 (in other words: a state determining circuit) configured to determine whether the data is to be relayed to the terminal device based on the state information. The state determiner 302, the receiver 304 and the relay determiner 306 may be coupled with each other, e.g. via an electrical connection 308 such as e.g. a cable or a computer bus or via any other suitable electrical connection to exchange electrical signals.

According to various embodiments, the operation state of reduced energy consumption may be an idle state.

According to various embodiments, the operation state of reduced energy consumption may be an RRC idle state.

According to various embodiments, the stateful paging guard device 300 may be provided in a core network of a mobile radio communication system, to which the terminal device belongs.

According to various embodiments, the stateful paging guard device 300 may be provided in a serving gateway of the core network.

According to various embodiments, the stateful paging guard device 300 may be provided between a serving gateway of the core network and a mobility management entity of the core network.

According to various embodiments, the received data may be data for changing the operation state of the terminal device from an operation state of reduced energy consumption to an operation state of normal operation.

According to various embodiments, the received data may be paging data or data that would result in paging data to be sent to the terminal device.

According to various embodiments, the terminal device may be a machine-to-machine type terminal device.

FIG. 4 shows a stateful paging guard device 400 according to an embodiment. The stateful paging guard device 400 may, similar to the stateful paging guard device 300 of FIG. 3, include a state determiner 302, a receiver 304, and a relay determiner 306. The stateful paging guard device 400 may furthermore include a state storage 402, like will be described in more detail below. The stateful paging guard device 400 may furthermore include a specific data determiner 404 (in other words a specific data determining circuit), like will be described in more detail below. The stateful paging guard device 400 may furthermore include a data discarding instruction transmitter 406, like will be described in more detail below. The stateful paging guard device 400 may furthermore include a state polling circuit 408, like will be described in more detail below. The state determiner 302, the receiver 304, the relay determiner 306, the state storage 402, the specific data determiner 404, the data discarding instruction transmitter 406, and the state polling circuit 408 may be coupled with each other, e.g. via an electrical connection 410 such as e.g. a cable or a computer bus or via any other suitable electrical connection to exchange electrical signals.

According to various embodiments, the state polling circuit 408 may be configured to transmit a request for the state information to a network device (for example to an S-GW), and to receive the requested state information from the network device.

According to various embodiments, the state storage 402 may be configured to store state information indicating whether the terminal device is in an operation state of reduced energy consumption.

According to various embodiments, the state determiner 302 may be configured to determine the state information based on the state information stored in the state storage 402.

According to various embodiments, the state storage 402 may further be configured to, in case both the state information stored in the state storage 402 is state information indicating that the terminal device is in an operation state of reduced energy consumption and it is determined by the relay determiner 306 that the data is to be relayed to the terminal device, store information indicating that the terminal device is not in an operation state of reduced energy consumption as state information.

According to various embodiments, the state storage 402 may be further configured to, in case both the state information stored in the state storage 402 is state information indicating that the terminal device is not in an operation state of reduced energy consumption and the receiver 304 has not received data to be relayed to the terminal device for a pre-determined period of time, store information indicating that the terminal device is in an operation state of reduced energy consumption as state information.

According to various embodiments, the specific data determiner 404 may be configured to determine whether the received data fulfils a pre-determined criterion.

According to various embodiments, the pre-determined criterion may be a criterion related to a sender of the data. For example, only for data sent from a pre-determined sender, it may be determined that the data fulfils the pre-determined criterion.

According to various embodiments, the pre-determined criterion may be a criterion related to the content of the data. For example, only for data including a pre-determined content, it may be determined that the data fulfils the pre-determined criterion.

According to various embodiments, the pre-determined criterion may be a criterion related to an encrypted counter value in the data. For example, only for data including a counter value that is higher than a previously received counter value, and for which the counter value is encrypted by a pre-determined key, it may be determined that the data fulfils the pre-determined criterion.

According to various embodiments, the relay determiner 306 may further be configured to determine whether the data is to be relayed to the terminal device based on whether the received data fulfils the pre-determined criterion.

According to various embodiments, the relay determiner 306 may be configured to determine that the data is to be relayed to the terminal device in case the state information is indicating that the terminal device is not in an operation state of reduced energy consumption.

According to various embodiments, the relay determiner 306 may be configured to determine that the data is not to be relayed to the terminal device in case both the state information is indicating that the terminal device is in an operation state of reduced energy consumption and the data does not fulfill the pre-determined criterion.

According to various embodiments, the relay determiner 306 may be configured to determine that the data is to be relayed to the terminal device in case both the state information is indicating that the terminal device is in an operation state of reduced energy consumption and the data fulfils the pre-determined criterion.

According to various embodiments, the stateful paging guard device 300 may further include a data transmitter (not shown) configured to relay (in other words: to transmit) the data to the terminal device in case it is determined that the data is to be relayed to the terminal device. According to various embodiments, the stateful paging guard device 300 may further include an relay instruction transmitter (not shown) configured to transmit (for example to a S-GW) a relay instruction instructing relaying (in other words: transmitting) the data to the terminal device in case it is determined that the data is to be relayed to the terminal device. According to various embodiments, the stateful paging guard device 300 may relay (in other words: transmit) the data to the terminal device, for example in a case where the stateful paging guard device 300 is provided in a serving gateway or is provided between a serving gateway and the MME. According to an example, the transmitter may be configured to transmit paging data to the terminal device in case it is both determined that the data is to be relayed to the terminal device and that the terminal device is in an operation state of reduced energy consumption, and may then relay (in other words: transmit) the data to the terminal device, for example in a case where the stateful paging guard device 300 is provided in the S-GW.

According to various embodiments, the data discarding instruction transmitter 406 may be configured to transmit a discarding instruction instructing discarding of the data in case it is determined that the data is not to be relayed to the terminal device.

According to various embodiments, the stateful paging guard device may further include a data discarder (not shown) configured to discard the data in case it is determined that the data is not to be relayed to the terminal device.

According to various embodiments, the stateful paging guard device 400 may furthermore include a guarded terminal device storage (not shown) configured to store information indicating that the stateful paging guard device 400 is to be applied for the terminal device. According to various embodiments, the stateful paging guard device 400 may operate like described herein for terminal devices, for which information is stored in the guarded terminal device storage, and may not operate (or may operate to relay all data or may operate to transmit an instruction to relay all data) for terminal devices, for which information is not stored in the guarded terminal device storage.

According to various embodiments, the stateful paging guard device 400 may furthermore include a criterion information storage (not shown) configured to store information indicating the pre-determined criterion, for example in correlation with information identifying the terminal device.

FIG. 5 shows a flow diagram 500 illustrating a method for controlling a stateful paging guard device according to an embodiment. In 502, state information indicating whether a terminal device is in an operation state of reduced energy consumption may be determined. In 504, data directed to the terminal device may be received. In 506, it may be determined whether the data is to be relayed to the terminal device based on the state information.

According to various embodiments, the operation state of reduced energy consumption may be an idle state.

According to various embodiments, the operation state of reduced energy consumption may be an RRC idle state.

According to various embodiments, the stateful paging guard device may be provided in a core network of a mobile radio communication system, to which the terminal device belongs.

According to various embodiments, the stateful paging guard device may be provided in a serving gateway of the core network.

According to various embodiments, the stateful paging guard device may be provided between a serving gateway of the core network and a mobility management entity of the core network.

According to various embodiments, the received data may be data for changing the operation state of the terminal device from an operation state of reduced energy consumption to an operation state of normal operation.

According to various embodiments, the received data may be paging data or data that would result in paging data to be sent to the terminal device.

According to various embodiments, the terminal device may be a machine-to-machine type terminal device.

According to various embodiments, the state information may be polled from a network device (for example an S-GW). According to various embodiments, a request for the state information may be transmitted to a network device (for example to an S-GW), and the requested state information may be received from the network device.

According to various embodiments, state information indicating whether the terminal device is in an operation state of reduced energy consumption may be stored.

According to various embodiments, the state information may be determined based on the state information stored in the state storage.

According to various embodiments, in case both the stored state information is state information indicating that the terminal device is in an operation state of reduced energy consumption and it is determined that the data is to be relayed to the terminal device, information indicating that the terminal device is not in an operation state of reduced energy consumption may be stored as state information.

According to various embodiments, in case both the stored state information is state information indicating that the terminal device is not in an operation state of reduced energy consumption and data to be relayed to the terminal device has not been received for a pre-determined period of time, information indicating that the terminal device is in an operation state of reduced energy consumption may be stored as state information.

According to various embodiments, it may be determined whether the received data fulfils a pre-determined criterion.

According to various embodiments, the pre-determined criterion may be a criterion related to a sender of the data. For example, only for data sent from a pre-determined sender, it may be determined that the data fulfils the pre-determined criterion.

According to various embodiments, the pre-determined criterion may be a criterion related to the content of the data. For example, only for data including a pre-determined content, it may be determined that the data fulfils the pre-determined criterion.

According to various embodiments, the pre-determined criterion may be a criterion related to an encrypted counter value in the data. For example, only for data including a counter value that is higher than a previously received counter value, and for which the counter value is encrypted by a pre-determined key, it may be determined that the data fulfils the pre-determined criterion.

According to various embodiments, it may be determined whether the data is to be relayed to the terminal device based on whether the received data fulfils the pre-determined criterion.

According to various embodiments, it may be determined that the data is to be relayed to the terminal device in case the state information is indicating that the terminal device is not in an operation state of reduced energy consumption.

According to various embodiments, it may be determined that the data is not to be relayed to the terminal device in case both the state information is indicating that the terminal device is in an operation state of reduced energy consumption and the data does not fulfill the pre-determined criterion.

According to various embodiments, it may be determined that the data is to be relayed to the terminal device in case both the state information is indicating that the terminal device is in an operation state of reduced energy consumption and the data fulfils the pre-determined criterion.

According to various embodiments, the data may be relayed to the terminal device in case it is determined that the data is to be relayed to the terminal device. According to various embodiments, a relay instruction instructing relaying (in other words: transmitting) the data to the terminal device may be transmitted (for example to a S-GW) in case it is determined that the data is to be relayed to the terminal device. According to various embodiments, the data may be relayed (in other words: transmitted) to the terminal device, for example in a case where the stateful paging guard device 300 is provided in a serving gateway or is provided between a serving gateway and the MME. According to an example, paging data may be transmitted to the terminal device in case it is both determined that the data is to be relayed to the terminal device and that the terminal device is in an operation state of reduced energy consumption, and then the data may be relayed (in other words: transmitted) to the terminal device, for example in a case where the stateful paging guard device 300 is provided in the S-GW.

According to various embodiments, a discarding instruction instructing discarding of the data may be transmitted in case it is determined that the data is not to be relayed to the terminal device.

According to various embodiments, the data may be discarded in case it is determined that the data is not to be relayed to the terminal device.

According to various embodiments information indicating that the method for controlling a stateful paging guard device is to be applied for the terminal device may be stored. According to various embodiments, the methods for controlling a stateful paging guard device like described herein may be applied to terminal devices, for which information is stored in the guarded terminal device storage, and may not be applied to terminal devices, for which information is not stored in the guarded terminal device storage. According to various embodiments, for terminal devices, for which information is not stored in the guarded terminal device storage, all data may be relayed or an instruction to relay all data may be transmitted.

According to various embodiments, information indicating the pre-determined criterion may be stored, for example in correlation with information identifying the terminal device.

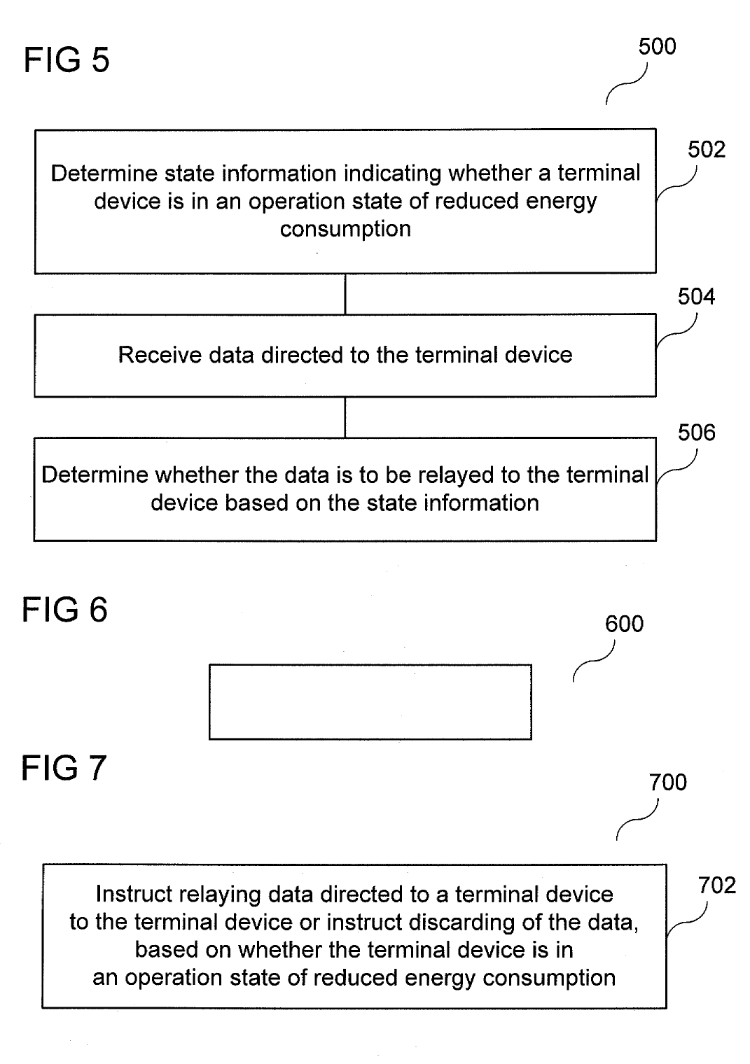

FIG. 6 shows a stateful paging guard device 600 according to an embodiment. The stateful paging guard device 600 may be configured to instruct relaying of data directed to a terminal device (not shown in FIG. 6) to the terminal device or instruct discarding of the data, based on whether the terminal device is in an operation state of reduced energy consumption.

FIG. 7 shows a flow diagram 700 illustrating a method for controlling a stateful paging guard device according to an embodiment. In 702, relaying of data directed to a terminal device to the terminal device may be instructed (for example a S-GW may be instructed) or discarding of the data may be instructed (for example a S-GW may be instructed), based on whether the terminal device is in an operation state of reduced energy consumption.

According to various embodiments, devices and methods may be provided for the machine-to-machine (M2M) market, which may be emerging. According to various embodiments, not only human beings may be connected via cellular mobile networks but also machines. For example, an M2M system may include a device or group of devices capable of replying to request for data contained within those devices or capable of transmitting data contained within those devices autonomously. According to various embodiments, an M2M system may also includes a communications link to connect the device or group of devices to a computer server or another device and an artificially intelligent agent, software agent, process, or interface by which the data can be analyzed, reported, and/or acted upon. According to various embodiments, M2M systems may be based on automated intelligence. Examples for M2M enabled devices connected to a system are fleet management systems over remote controlling and/or accounting to health supervision.

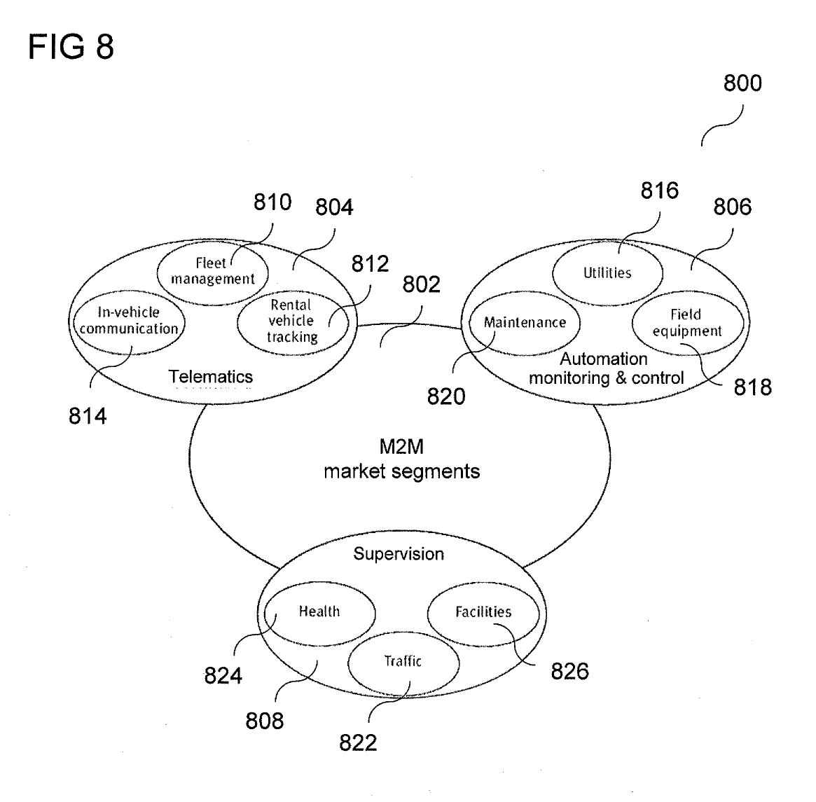

FIG. 8 shows a diagram 800 illustrating machine to machine market segments according to an embodiment. The M2M market segments 802 may include telematics 804, automation monitoring and control 806, and supervision 808. Telematics 804 may include fleet management 810, rental vehicle tracking 812, and in-vehicle communication 814. Automation monitoring and control 806 may include utilities 816, field equipment 818, and maintenance 820. Supervision 808 may include traffic 822, health 824, and facilities 826.

According to various embodiments, a vendor machine for beverages may communicate with the owner and may order new supplies autonomously. A rent production machine may generate an account of usage and may report it to the rental agency. The number of such M2M enabled devices may be increasing in the future. Cellular networks for mobile devices have become a main communication technique because of the flexibility and reliability. Therefore operators of cellular networks may be under pressure to cope with increasing M2M subscriptions. According to various embodiments, devices and methods may be provided for improving the resource management to be able to offer attractive M2M tariffs and meet new business models. For example, resource management may be provided which may take times of low network traffic into account and may perform a load balance in terms of time, location and network resources.

According to various embodiments, the M2M devices may be in an energy efficient state most of the time in order to safe battery lifetime. According to various embodiments, the user may be provided with the ability to trigger the device in order to communicate with it.

In 3GPP the following service requirements may be defined: 3GPP TS 22.368 V10.2.0 (2010-09); Technical Specification; 3rd Generation Partnership Project; Technical Specification Group Services and System Aspects; Service requirements for Machine-Type Communications (MTC); Stage 1 (Release 10).

According to various embodiments, devices and methods may be provided for MTC device triggering.

According to various embodiments, the network may be able to trigger MTC devices to initiate communication with an MTC server based on a trigger indication from the MTC server.

According to various embodiments, an MTC device may be able to receive trigger indications from the network and may establish communication with the MTC server when receiving the trigger indication. According to various embodiments, possible options may include:
Receiving trigger indication when the MTC device is offline;
Receiving trigger indication when the MTC device is online, but has no data connection established; and
Receiving trigger indication when the MTC device is online and has a data connection established.

According to various embodiments, “online” may mean that the MTC Device is attached to the network for MT signaling or user plane data. When the MTC Device is offline (for example detached, for example in an operation state of reduced energy consumption) the MTC Device may listen to trigger indications on e.g. a broadcast or paging channel.

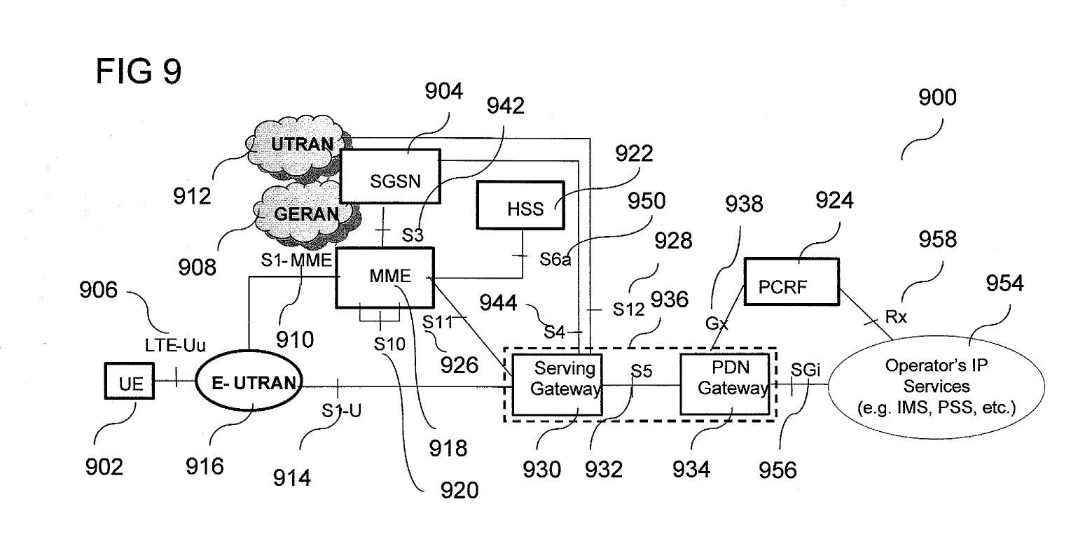

FIG. 9 shows a network architecture 900, for example an LTE network architecture, in accordance with an embodiment. The network architecture 900 may be a Non-Roaming 3GPP Core Network Architecture with three different Radio Access Networks (RANs). The 3GPP Network Architecture 900 may include an Evolved Packet Core (EPC) and a General Packet Radio Service (GPRS) Core, which may be connected with each other by various interfaces, as will be described in more detail below. As shown in FIG. 9, the GPRS Core may include a Serving GPRS Support Node (SGSN) 904, which may be coupled to different Radio Access Networks, such as e.g. to a GSM EDGE Radio Access Network (GERAN) 908 (which may also be referred to as 2G or 2.5G) via a Gb interface, and/or to a UMTS Terrestrial Radio Access Network (UTRAN) 912 via an Iu interface. In an embodiment, UTRAN may stand for UMTS Terrestrial Radio Access Network and may be a collective term for the NodeBs and Radio Network Controllers (RNCs) which make up the UMTS radio access network. This communications network, commonly referred to as 3G, may carry many traffic types from real-time Circuit Switched to IP based Packet Switched. The UTRAN 912 may include at least one NodeB that may be connected to at least one Radio Network Controller (RNC). An RNC may provide control functionalities for one or more NodeB(s). A NodeB and an RNC may be the same device, although typical implementations may have a separate RNC located in a central location serving multiple NodeBs. An RNC together with its corresponding NodeBs may be called the Radio Network Subsystem (RNS). There may be more than one RNS provided per UTRAN.

Furthermore, in an embodiment, the following entities or components may be provided in the general 3GPP Network Architecture 900:
an evolved UMTS Terrestrial Radio Access Network (E-UTRAN) 916;
a Home Subscriber Server (HSS) 922; and
a Policy and Charging Rules Function (PCRF) entity 924.

E-UTRAN may be understood as being the new 3GPP Radio Access Network for LTE (3.9G) that is currently being worked on. The proposed E-UTRA air interface may use OFDMA for the downlink transmission direction (tower to handset) and Single Carrier FDMA (SC-FDMA) for the uplink transmission direction (handset to tower). It may employ MIMO (Multiple-Input Multiple-Output) with a plurality of antennas, e.g. with up to four antennas per station. The use of OFDM (Orthogonal Frequency Division Multiplexing) may enable E-UTRA to be much more flexible in its use of spectrum than the older CDMA based systems, such as e.g. UTRAN. OFDM may have a link spectral efficiency greater than CDMA, and when combined with modulation formats such as 64QAM (Quadrature Amplitude Modulation), and techniques as MIMO, E-UTRA may be more efficient than W-CDMA (Wideband CDMA) with HSDPA (High Speed Downlink Packet Access) and HSUPA (High Speed Uplink Packet Access).

Furthermore, as will be described in more detail below, the EPC may include a Mobility Management Entity (MME) 918 and a Serving Gateway (S-GW) 930 (in FIG. 9 shown as separate devices, however, the MME 918 and the S-GW 930 may also be implemented in one combined entity), a 3GPP Anchor entity and an SAE (System Architecture Evolution) Anchor entity.

In an embodiment, the E-UTRAN 916 may be connected to the Serving Gateway 930 via an S1-U interface 914. In an embodiment, the E-UTRAN 916 may be connected to the MME 918 via an S1-MME interface 910.

In an embodiment, a UE 902 may be connected to the E-UTRAN 916 by an LTE-Uu interface 906.

Furthermore, the trusted non-3GPP IP entity may be connected to the SAE Anchor entity via an S2a interface. In an embodiment, the S2a interface may be based on the Proxy Mobile IPv6 (PMIP) and in order to support accesses that do not support PMIP also Mobile IPv4.

Furthermore, the SGSN 904 may be connected to the MME 918 in the EPC via an S3 interface 942, which may provide and enable a user and bearer information exchange for inter 3GPP access network mobility in idle and/or active state. In an embodiment, the S3 interface 942 may be based on the GPRS tunneling protocol (GTP) and the Gn interface as it may be provided between SGSNs. The SGSN 904 may further be connected to the 3GPP Anchor entity via an S4 interface, which may provide the user plane with related control and mobility support between the GPRS Core and the 3GPP Anchor function of the S-GW 930 and may be based on the GTP protocol and the Gn reference point as provided between SGSN 904 and GGSN (GPRS Support Node).

The MME S-GW may be connected to the 3GPP Anchor entity via an S5a interface and the 3GPP Anchor entity may be connected to the SAE Anchor entity via an S5b interface.

Furthermore, the HSS 922 may be connected to the MME 918 via an S6a interface 950, which may provide or enable transfer of subscription and authentication data for authenticating/authorizing user access to the evolved system (AAA interface) between the MME 918 and the HSS 922.

The PCRF 924 may be connected to the EPC via an S7 interface, which may provide transfer of Quality of Service (QoS) policy and charging rules from the PCRF 924 to the Policy and Charging Enforcement Function (PCEF) in an PDN Gateway 934 of the EPC. In an embodiment, the S7 interface may be based on an Gx interface 938.

IP services 954 such as e.g. (3G) IP Multimedia Subsystem (IMS), (3G) Packet Switches Streaming (PSS), M2M application, etc., may be provided via an SGi interface 956 to the SAE Anchor entity and/or via an Rx interface 958 to the PCRF 924. In an embodiment, the SGi interface 956 may be the interface between the PDN Gateway 934 and the packet data network. The packet data network may be an operator external public or private packet data network or an intra operator packet data network, e.g. for provision of IP services such as e.g. of IMS. The SGi interface 956 may correspond to the Gi and Wi interfaces and support any 3GPP or non-3GPP access. The Rx interface 958 may be the interface between the IP services and the PCRF 924.

In various embodiments, the MME may be connected to other MMEs by an S10 interface 920 for MME relocation and MME to MME information transfer.

In various embodiments, the MME 918 may be connected to the Serving Gateway 930 by an S11 interface 926.

In various embodiments, the Serving Gateway 930 may be connected to the PDN gateway 934 by an S5 interface 932. In various embodiments, the Serving Gateway 930 may be connected to the SGSN 904 by an S4 interface 944. In various embodiments, the Serving Gateway 930 may be connected to the UTRAN 912 by an S12 interface 928.

In various embodiments, the Serving Gateway (SGW) 930 and the PDN Gateway (PGW) 934 may be one functional entity, as indicated by dashed box 936.

According to various embodiments, the EPC may include as its subcomponents the MME 918, the SGW 930, and the PGW 934.

According to various embodiments, the MME (Mobility Management Entity) 918 may be the key control-node for the LTE access-network. It may be responsible for idle mode UE tracking and paging procedure. It may be involved in the bearer activation/deactivation process and may also be responsible for choosing the SGW 930 for a UE 902 at the initial attach and at time of intra-LTE handover involving Core Network (CN) node relocation. It may be responsible for authenticating the user (by interacting with the Home Subscriber Server (HSS 922)). The Non-Access Stratum (NAS) signaling may terminate at the MME 918 and it may also be responsible for generation and allocation of temporary identities to UEs. It may check the authorization of the UE to camp on the service provider's Public Land Mobile Network (PLMN) and may enforce UE roaming restrictions. The MME 918 may be the termination point in the network for ciphering/integrity protection for NAS signaling and may handle the security key management. Lawful interception of signaling may also be supported by the MME 918. The MME 918 also may provide the control plane function for mobility between LTE and 3GPP technologies with the S3 interface 942 terminating at the MME 918 from the SGSN 904. The MME 918 may terminate the S6a interface 950 towards the home HSS 922 for roaming UEs.

The SGW (Serving Gateway) 930 may route and forward user data packets, while also acting as the mobility anchor for the user plane during inter-eNodeB handovers and as the anchor for mobility between LTE and other 3GPP technologies (for example terminating S4 interface 944 and relaying the traffic between 2G/3G systems and PGW 934). For idle state UEs, the SGW 930 may terminate the DL (downlink) data path and may trigger paging when DL data arrives for the UE. It may manage and store UE contexts, for example parameters of the IP bearer service, network internal routing information. It may also perform replication of the user traffic in case of lawful interception.

According to various embodiments, the PGW (PDN Gateway) 934 may provide connectivity from the UE 902 to external packet data networks by being the point of exit and entry of traffic for the UE 902. A UE 902 may have simultaneous connectivity with more than one PGW 934 for accessing multiple PDNs. The PGW 934 may perform policy enforcement, packet filtering for each user, charging support, lawful Interception and packet screening. The PGW may further act as the anchor for mobility between 3GPP and non-3GPP technologies such as WiMAX and 3GPP2 (CDMA 1x and EvDO (Evolution-Data Optimized)).

According to various embodiments, the M2M devices may be in an operation state of reduced energy consumption, for example in an idle state, most of the time. In the idle state, the devices may be using minimal resources just sufficient to listen to a paging channel. In LTE and above the paging mechanism may be energy efficient. According to various embodiments, it may be very likely that paging may fulfill the desirements regarding triggering described above. According to various embodiments, the stateful paging guard device (in other words the paging filter) described above with reference to the stateful paging guard device may be used also for other devices to trigger an M2M device.

According to various embodiments, information sent out in broadcast mode by a base station (eNB) may be the same for all M2M devices that are residing within coverage of the base station. That may mean that in any given cell all M2M devices in RRC_IDLE may receive the same pieces of broadcast information. Unlike for M2M devices in RRC_CONNECTED, there may be no dedicated signaling for M2M devices in RRC_IDLE state. According to various embodiments, in LTE, the PDSCH (Physical Downlink Shared Channel) may be used for the paging message and the indication may be provided via the PDCCH (Physical Downlink Control Channel). According to various embodiments, in LTE, the PDCCH signaling may be very short in duration, and therefore the impact on UE battery life of monitoring the PDCCH from time to time may be low. According to various embodiments, therefore, the normal PDCCH signaling may be used to carry a paging indicator or the equivalent of a paging indicator, while the detailed paging information may be carried on the PDSCH in a resource block indicated by the PDCCH. According to various embodiments, paging indicators sent on the PDCCH may use a single fixed identifier called the Paging RNTI (Radio Network Temporary Identifier; P-RNTI).

According to various embodiments, a result of the paging procedure may be one or more of the following:
transmit paging information to an M2M device in RRC_IDLE, and/or
inform the M2M device in RRC_IDLE and in RRC_CONNECTED about a SI-change, and/or
inform the M2M device about PWS (Public Warning System) notifications.

According to various embodiments, when DL data intended for a UE in RRC_IDLE state arrives at the S-GW, the MME may initiate paging as shown below. The paging mechanism is explained in more detail below and the network filter (in other words: the stateful paging guard device) may be applied to this paging mechanism.

According to various embodiments, when paged, the device may switch from idle state to connected state and may build a connection to the network in order to establish a data communication. The idle state in LTE and above may be optimized regarding energy efficiency. The M2M Devices may be triggered by the M2M application server in case the device is supposed to establish a connection.

For example, this may be done via the circuit switch (CS) domain. The M2M device may be called with its MSISDN (Mobile Subscriber ISDN (Integrated Services Digital Network Number). With this method there may be a low probability that a device is triggered by mistake or intentionally by someone else than the owner of the device.

With the increasing number of M2M devices, a shortage in the E.164 addressing schema (MSISDN) for Machine-Type Communications may exist. An alternative may be a packet switched (PS) only Machine-Type Communication with fixed Ipv6 addresses for each device. In this case there may not be the possibility to trigger an M2M device via CS domain. The device may be paged by the network whenever data are sent to the device's network address.

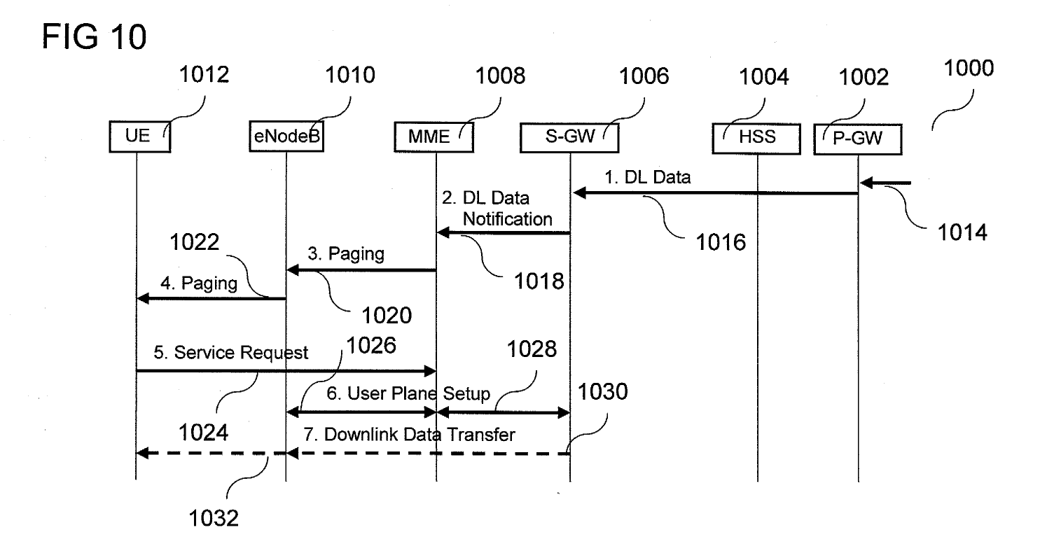

FIG. 10 shows a flow diagram 1000 illustrating a paging procedure in accordance with an embodiment. In the flow diagram 1000 of the paging procedure in E-UTRAN, signal flow between a P-GW (Packet Data Network Gateway) 1002, a HSS 1004, a S-GW 1006, an MME 1008, an eNodeB 1010, and terminal device 1012, for example an M2M device, for example an UE, is shown.

According to various embodiments, in case in 1014 data arrive for a certain M2M device 1012 through the packet data gateway 1002 in an LTE network, in 1016, the gateway 1002 may send these data to the corresponding serving gateway 1006 and from there right through to the M2M device 1012 in case the M2M device is in RRC_connected state. If no connection is established yet, the serving gateway 1006 may in 1018 send a paging message to the MME 1008 (incoming data). MME 1008 in 1020 may send a message to all eNodeBs (for example including the eNodeB 1010) within the paging area the M2M device 1012 is registered in. All eNodeBs in the paging area may, in 1022, send a paging message to the specific M2M device 1012. The M2M device 1012 in idle mode may listen to the paging channel, may receive the paging message and may switch to RRC_connected mode. For example, the M2M device 1012 in 1024 may send a service request to the MME 1008, and user plane setup may be established between the MME 1008 and the eNodeB 1010 in 1026, and between the MME 1008 and the S-GW 1006 in 1028. A data connection may be established and the serving gateway 1006 may in 1030 and 1032 send the cached received data to the M2M device 1012 via the eNodeB 1010.

This paging procedure may happen very easily by mistake or intentionally by someone else but an authorized person (for example the owner), for example when a port scan is performed in the network. It may be simple to learn the Ipv6 address of an M2M device owned by a competitor. It may happen that someone is waking up the device owned by a competitor on regular basis in order to increase the energy consumption of that device which may be considered as a kind of Denial-of-Service attack.

According to various embodiments, devices and methods are provided to prevent an M2M device from being paged or triggered by someone not authorized, for example by someone else than the owner of that device.

According to various embodiments, a stateful paging guard device (for example a paging filter) may be installed in the packet data gateway or in the serving data gateway in an LTE network. According to various embodiments, in case a data connection is established already the communication may be performed as usual. According to various embodiments, in case the connection is not established yet, the gateway with a paging filter enabled may send the corresponding message to the MME only in the following specified cases.

According to various embodiments, the first data packet sent from the M2M server to the M2M device may have to fulfill pre-determined criteria to trigger the paging process in the network. According to various embodiments, the packet may be specific to a single device. According to various embodiments, the knowledge of the exact packet format may not be sufficient to wake-up a device. According to various embodiments, the packet may have to contain the data specific to the device or a group of devices like all devices operated by the same owner. According to various embodiments, these data may not be learnt easily by a third party as the IP addresses. Therefore the stateful paging guard device (for example paging filter) according to various embodiments, may enable the network to prevent an M2M device from being waked-up by anything else than a wake-up packet intentionally sent by an authorized person, for example by the device owner.

According to various embodiments, instead of or in addition to device specific data within the initial data packet, cryptographic methods like asymmetric encryption to digitally sign the initial data packet may be provided. The cryptographic based method may lead to more security, because the M2M device may also be protected against an attacker who is able to sniff the network traffic. According to various embodiments, protections against replay attacks (for example resending sniffed packets to the device again and again) may be prevented in a cryptographically protected packet filter by adding a counter.

According to various embodiments, a paging filter in packet data gateway or external entity may be provided.

According to various embodiments, a pre-determined wake-up packet format to trigger a connection establishment may be provided.

According to various embodiments, a device specific (or group of devices specific) and/or digitally signed wake-up packet data may be provided to prevent unauthorized wake-up.

According to various embodiments, a company may run several vendor machines for cigarettes. The vendor machines may be equipped with a cellular modem card for administration (for example remote price adjustments), logistics (for example filling levels), and maintenance (for example diagnostics or firmware update, etc.) and a solar panel as power supply. In order to save energy and data traffic, all machines may be in idle mode unless they are triggered by the M2M application server operated by the company.

According to various embodiments, any data sent to a vendor machine may be routed through the Serving Gateway. If the vendor machine (which may be the target M2M device) is in RRC_connected state, the data may be sent from Serving Gateway to the target M2M device. In case the target M2M device is RRC_idle state, the Serving Gateway may cache the data and may send a message the MME in order to page the target device.

According to various embodiments, a packet filter (or a stateful paging guard device) may be provided in the Serving Gateway (or may be provided as a separate entity between SGW and MME). According to various embodiments, in case the target device (for example the terminal device) is in RRC_connected, the data may be sent to the target device as usual, but in case the device is not in RRC_connected state, the packet filter may look at the first packet sent to the target device. According to various embodiments, this packet may have to fulfill the defined criteria in order pass the filter. According to various embodiments, if any of the criteria are not fulfilled, the data may be discarded and the target device may not be paged.

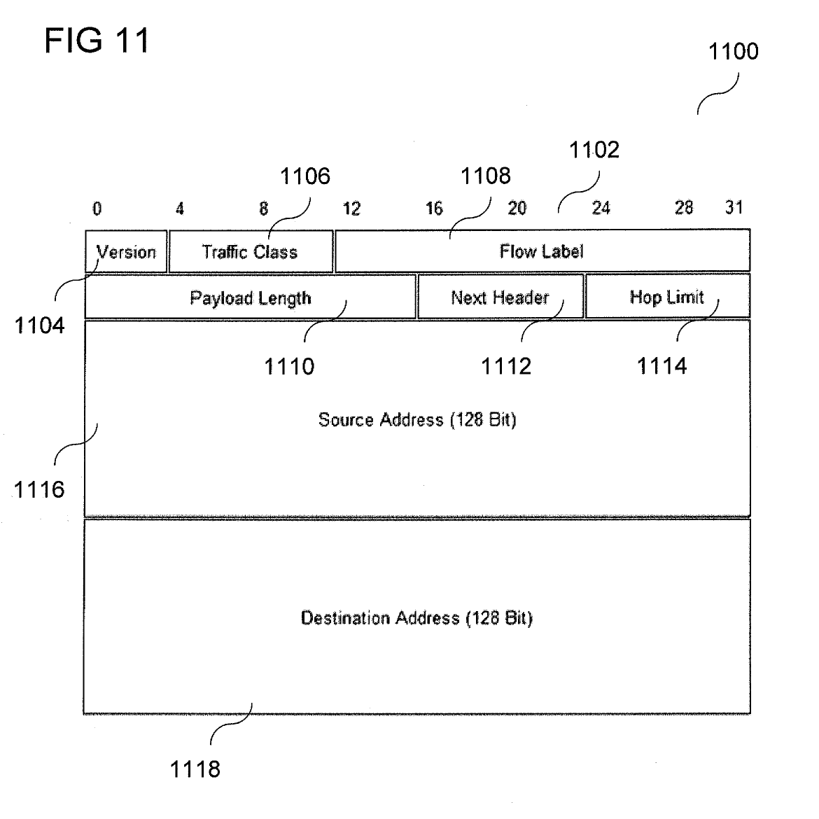

FIG. 11 shows a packet header 1100, for example an IPv6 header, in accordance with an embodiment. The number of consecutive bits in the header 1100 may be denoted by reference sign 1102, and may not be a part of the header 1100 itself.

The header 1100 may include information indicating a version 1104 including 4 bits representing the value 6 (in other words: the bit sequence 0110), information indicating a traffic class 1106 including 8 bits, information indicating a flow label 1108 including 20 bits, information indicating a payload length 1110 including 16 bits, information indicating a next header 1112 including 8 bits, information indicating a hop limit 1114 including 8 bits, information indicating a source address 1116 including 128 bits, and information indicating a destination address 1118 including 128 bits.

According to various embodiments, the stateful paging guard device (in other words: the packet filter) may look up the source address field in the IP Header, and only if the source address matches the IP address of one of the for the target device listed M2M server, the message to MME may be sent. According to various embodiments, in any other cases, the data may be discarded. This may be the simplest level of paging filter because an attacker only may need to know the IP address of a listed M2M server and may spoof this address in order to by-pass the paging filter.

According to various embodiments, a stateful paging guard device (in other words: the paging filter) may instead or in addition also look into the payload of the first data packet, and only if the source address and the payload, for example the beginning of the payload, match a listed value for the target device, the paging message may be sent. As an example the payload may have to look like this:

<wake-up message >DEVICE: vendor265
CODE:nhxy7321893y8721652g2a76v2y6v</wake-up message>

According to various embodiments, only if the source address, the device name and the code in the payload of the first packet match values listed in the paging filter, the paging may be proceeded. According to various embodiments, in any other case, the data may be discarded. To by-pass this level paging filter, an attacker may have to sniff the network traffic. The knowledge of the M2M server's IP address may not be sufficient. According to this embodiment, the paging filter may desire to look up the payload. Therefore at least the first wake-up packet may not be encrypted or sent via an IPsec tunnel Furthermore, in this embodiment, the wake-up packet may be static. Once an attacker knows how the packet looks like, it may be sent to the target device at any time and may always pass the paging filter until the code is changed.

According to various embodiments, a stateful paging guard device (in other words a paging filter) may works with cryptographic methods. According to various embodiments, the public key of the M2M server and a counter per M2M server may be stored in addition to the other paging filter values of the paging filter described above. According to various embodiments, the payload of the wake-up packet may include a counter and may digitally be signed by the M2M server. For example, this may look like this:

<wake-up message>DEVICE: vendor265
CODE:nhxy7321893y8721652g2a76v2y6v COUNTER:5243</wake-up
message> MAC:8xn843xnr743nxr78n743xnz7x

According to various embodiments, the paging filter may check two additional criteria: The counter value may have to be above the stored value and a Message Authentication Code (for example including the secret key encrypted hash value of the wake-up massage; inclusive the counter) may have to be correct. In case an attacker would be able to intercept a wake-up packet, resending this packet to the device with a spoofed IP address would not pass the paging filter because the counter value is not above the stored. Increasing the counter value would lead to an invalid Message Authentication Code which may not be generated without the secret key stored in the M2M server. The paging filter according to this embodiment may be the most secure but also the most complex paging filter. The complexity may be increased by the need of a key distribution and additional communication between M2M server and paging filter in case the counter has to be reset or synchronized.

According to various embodiments, before the M2M server may be able to communicate with one or more vendor machines a valid trigger packet may have to be sent. According to various embodiments, setup messages between the M2M server and the paging filter (in other words: the stateful paging guard device) may be defined (e.g. to set/change a devices code or reset a counter).

According to various embodiments, denial of service (DoS) attacks through permanent paging or triggering may be prevented.

According to various embodiments, unintended paging leading to an increased energy consumption and data traffic may be avoided.

According to various embodiments, the stateful paging guard device (in other words: the paging filter) may enable the network to prevent an M2M device from being waked-up by anything else than a wake-up packet intentionally sent by the device owner.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A stateful paging guard device comprising:
a state determiner configured to determine state information indicating whether a terminal device is in an operation state of reduced energy consumption;
a receiver configured to receive data directed to the terminal device; and
a relay determiner configured to determine whether the data is to be relayed to the terminal device based on the state information.

2. The stateful paging guard device of claim 1,
wherein the stateful paging guard device is provided in a core network of a mobile radio communication system, to which the terminal device belongs.

3. The stateful paging guard device of claim 1,
wherein the received data is data for changing the operation state of the terminal device from an operation state of reduced energy consumption to an operation state of normal operation.

4. The stateful paging guard device of claim 1, further comprising:
a state storage configured to store state information indicating whether the terminal device is in an operation state of reduced energy consumption.

5. The stateful paging guard device of claim 1, further comprising:
a state polling circuit configured to transmit a request for the state information to a network device, and to receive the requested state information from the network device.

6. The stateful paging guard device of claim 1, further comprising:
a specific data determiner configured to determine whether the received data fulfils a pre-determined criterion.

7. The stateful paging guard device of claim 6,
wherein the relay determiner is further configured to determine whether the data is to be relayed to the terminal device based on whether the received data fulfils the pre-determined criterion.

8. The stateful paging guard device of claim 1,
wherein the relay determiner is configured to determine that the data is to be relayed to the terminal device in case the state information is indicating that the terminal device is not in an operation state of reduced energy consumption.

9. The stateful paging guard device of claim 6,
wherein the relay determiner is configured to determine that the data is not to be relayed to the terminal device in case both the state information is indicating that the terminal device is in an operation state of reduced energy consumption and the data does not fulfill the pre-determined criterion.

10. The stateful paging guard device of claim 6,
wherein the relay determiner is configured to determine that the data is to be relayed to the terminal device in case both the state information is indicating that the terminal device is in an operation state of reduced energy consumption and the data fulfils the pre-determined criterion.

11. The stateful paging guard device of claim 1, further comprising:
a data discarding instruction transmitter configured to transmit a discarding instruction instructing discarding of the data in case it is determined that the data is not to be relayed to the terminal device.

12. A method for controlling a stateful paging guard device, the method comprising:
determining state information indicating whether a terminal device is in an operation state of reduced energy consumption;
receiving data directed to the terminal device; and
determining whether the data is to be relayed to the terminal device based on the state information.

13. The method of claim 12,
wherein the stateful paging guard device is provided in a core network of a mobile radio communication system, to which the terminal device belongs.

14. The method of claim 12,
wherein the received data is data for changing the operation state of the terminal device from an operation state of reduced energy consumption to an operation state of normal operation.

15. The method of claim 12, further comprising:
storing state information indicating whether the terminal device is in an operation state of reduced energy consumption.

16. The method of claim 12, further comprising:
transmitting a request for the state information to a network device and receiving the requested state information from the network device.

17. The method of claim 12, further comprising:
determining whether the received data fulfils a pre-determined criterion.

18. The method of claim 17,
wherein it is determined whether the data is to be relayed to the terminal device based on whether the received data fulfils the pre-determined criterion.

19. The method of claim 12,
wherein it is determined that the data is to be relayed to the terminal device in case the state information is indicating that the terminal device is not in an operation state of reduced energy consumption.

20. The method of claim 17,
wherein it is determined that the data is not to be relayed to the terminal device in case both the state information is indicating that the terminal device is in an operation state of reduced energy consumption and the data does not fulfill the pre-determined criterion.

21. The method of claim 17,
wherein it is determined that the data is to be relayed to the terminal device in case both the state information is indicating that the terminal device is in an operation state of reduced energy consumption and the data fulfils the pre-determined criterion.

22. The method of claim 12, further comprising:
transmitting a discarding instruction instructing discarding of the data in case it is determined that the data is not to be relayed to the terminal device.

23. A stateful paging guard device configured to instruct relaying of data directed to a terminal device to the terminal device or instruct discarding of the data, based on whether the terminal device is in an operation state of reduced energy consumption.

24. A method for controlling a stateful paging guard device, the method comprising instructing relaying of data directed to a terminal device to the terminal device or instructing discarding of the data, based on whether the terminal device is in an operation state of reduced energy consumption.
